(19) United States
(12) Patent Application Publication
(10) Pub. No.: US 2008/0192487 A1
(43) Pub. Date: Aug. 14, 2008

(54) COLLAPSIBLE LAMP SHADE AND ASSEMBLY

(75) Inventors: Gary D. Giegerich, Glenside, PA (US); Matthew T. Hartwig, Lansdale, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Matthew T. Hartwig, Lansdale, PA (US)

(21) Appl. No.: 12/027,777

(22) Filed: Feb. 7, 2008

Related U.S. Application Data
(60) Provisional application No. 60/888,857, filed on Feb. 8, 2007.

(51) Int. Cl. F21V 1/06

(52) U.S. Cl. 362/352

(57) ABSTRACT

A shade for mounting to a light bar to direct light from a bulb onto a billiard table or other desired area includes a plurality of shade portions having a generally arcuate-shape. Each shade portion includes a first side edge and a second side edge. The first side edge includes a first interlocking structure and the second side edge includes a second interlocking structure. The second interlocking structure of one of the shade portion engages the first interlocking structure of another shade portion to mount the shade portions to each other in an assembled configuration.

### CROSS REFERENCE TO RELATED APPLICATIONS

This application claims priority to U.S. Provisional Patent Application No. 60/888,857 filed on Feb. 8, 2007, entitled “Collapsible Lamp Shade and Assembly”.

### BACKGROUND OF THE INVENTION

The present invention relates generally to lamp shades and, more particularly, to a sectioned billiard lamp shade and assembly of the sectioned billiard lamp shade.

Referring to FIG. 1, conventional billiard shades 1 are typically constructed of a one-piece, frusto-conical shaped glass, fabric or wire frame construction. The billiard shade 1 typically includes an upper rim 1a with holes 1b therein for mounting to a light fixture or lighted bar (not shown). The billiard shade 1 takes up a relatively large amount of space during shipping between a manufacturer, a distributor, a retailer and/or a consumer and when being displayed on a retail shelf. In addition, this bulky one-piece billiard shade 1, typically constructed of glass, is relatively fragile during shipping and requires significant packing to protect the shade 1. The entire assembly requires expensive and large shipping boxes with significant packing to prevent breakage to transport from a manufacturer, to a distributor, to a retailer and eventually to a consumer.

It would be desirable to design a lamp shade and assembly that is relatively lightweight and consumes less space during shipping and display than conventional lamp shades. It is further desirable that the lamp shade have similar performance characteristics to the conventional lamp shades.

### BRIEF SUMMARY OF THE INVENTION

Briefly stated, the present invention is directed to a shade for mounting to a light fixture to direct light from a bulb onto a desired area. The shade includes a plurality of shade portions. Each shade portion includes a first side edge and a second side edge. The first side edge includes a first interlocking structure and the second side edge includes a second interlocking structure. The second interlocking structure of one of the shade portion engages the first interlocking structure of another shade portion to mount the shade portions to each other in an assembled configuration.

In another aspect, the invention is directed to a billiard light fixture for mounting over a billiard table and projecting light onto a billiard table and into a room wherein the billiard table is located and includes a light bar mounted over the billiard table. A first light bulb is mounted to the light bar. A first shade is mounted proximate the first light bulb to deflect light from the first light bulb onto the billiard table. The first shade includes a plurality of shade portion. Each shade portion includes a first side edge and a second side edge. The first side edge includes a first interlocking structure and the second side edge includes a second interlocking structure. The second interlocking structure of one of the shade portion engages the first interlocking structure of another shade portion to mount the shade portions to each other in an assembled configuration.

In another aspect, the invention is directed to a shade for use with a light fixture within a room used to project light into the room. The shade includes a knockdown frame that is movable between a working configuration and a shipping configuration. The knockdown frame encompasses a larger volume in the working configuration in comparison to an encompassed volume in the shipping configuration. A shade portion is removably mounted to the knockdown frame.

The shade of the present invention was developed in one aspect to make rigid lamp shades more compact for packaging and shipping. For example, a single four-piece shade can be packed in a carton approximately one-quarter (¼) the cubic volume of a single one-piece shade. The finished, fully assembled shade generally conforms to the same specifications as a standard one-piece shade and shade performance is nearly identical.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a top perspective view of a conventional billiard shade;

FIG. 2 is a top perspective, exploded view of a lamp shade in accordance with a first preferred embodiment of the present invention;

FIG. 3 is a side elevational view of three of the lamp shades of FIG. 2 assembled and mounted to a billiard light fixture;

FIG. 4 is a side elevational, exploded view of the lamp shade of FIG. 2;

FIG. 5 is a side perspective, partially exploded view of a lamp shade in accordance with a second preferred embodiment of the present invention; and

FIG. 6 is an exploded view of a knockdown frame of the lamp shade of FIG. 5.

### DETAILED DESCRIPTION OF THE INVENTION

Certain terminology is used in the following description for convenience only and is not limiting. The words “lower” and “upper” designate directions in the drawings to which reference is made. The word “outwardly” refers to directions toward and away from, respectively, the geometric center of a lamp shade in accordance with the present invention, and designated parts thereof. Unless specifically set forth herein, the terms “a”, “an” and “the” are not limited to one element but instead should be read as meaning “at least one”. The terminology includes the words noted above, derivatives thereof and words of similar import.

Referring to the drawings in detail, wherein like reference numerals indicate like elements throughout, FIGS. 2-4 show a first preferred embodiment of a lamp shade (“shade”), generally designated 10, in accordance with the present invention. However, the shade 10 is preferably a billiard lamp shade for mounting to a light bar 12 to direct light emitted from a bulb (not shown) onto a billiard table or other desired area (not shown). The shade 10 is not limited to use as a billiard shade or to being mounted to a light bar 12 and may be comprised of a shade for hanging on a pendant lamp (not shown) or to nearly any type of lamp or light fixture 24 that utilizes a shade. For example, the shade 10 may be configured for use as a table-lamp-type shade (not shown) that may or may not be hung from a light fixture.

The shade 10 is preferably comprised of removably connected first, second, third and fourth shade portions 14, 18, 20, 22. In the preferred embodiment, the shade portions 14, 18, 20, 22 are each constructed of one-quarter of an arcuate portion of the assembled shade 10. However, the shade 10 is not limited to being constructed of four, one-quarter shade portions 14, 18, 20, 22 and may be constructed of one-half, one-third, one-tenth or nearly any number of shade portions of the fully assembled shade 10 based upon user preferences and other packaging, shipping or storage preferences of a user. Additionally, the shade portions 14, 18, 20, 22 are preferably removably attached to each other to allow for assembly and disassembly but the shade portions 14, 18, 20, 22 may also be nonremovably attached to each other once assembled.

The shade portions 14, 18, 20, 22 preferably have a generally arcuate-shape and are preferably semi-transparent or translucent. However, the shade portions 14, 18, 20, 22 are not limited to being semi-transparent or translucent and may be comprised of nearly any material, whether transparent, opaque or semi-transparent, that is able to take on the general shape and size of the shade 10 and withstand the normal operating conditions of the shade 10.

The first shade portion 14 includes a first side edge 14a, a second side edge 14b and a top or apex edge 14c. The second shade portion 18 includes a first side edge 18a, a second side edge 18b and a top or apex edge 18c. The third shade portion 20 includes a first side edge 20a, a second side edge 20b and a top or apex edge 20c. The fourth shade portion 22 also includes a first side edge 22a, a second side edge 22b and a top or apex edge 22c. The shade portions 14, 18, 20, 22 preferably have a nearly identical structure to one another but are not limited to having nearly identical constructions and may have nearly any shape and configuration that results in the assembly of the shade portions 14, 18, 20, 22 comprising the general shape and configuration of the shade 10. For example, the shade portions 14, 18, 20, 22 may be shaped and sized to create a specific design or ornamental appearance for the shade 10 requiring differently shaped segments.

The shade portions 14, 18, 20, 22 preferably include an inner surface 24 and an outer surface 26. The inner surfaces 24 preferably face the light bulb or element within the light fixture 24 in the assembled configuration and the outer surfaces 26 preferably face away from the light fixture 24 and light bulb in the assembled configuration.

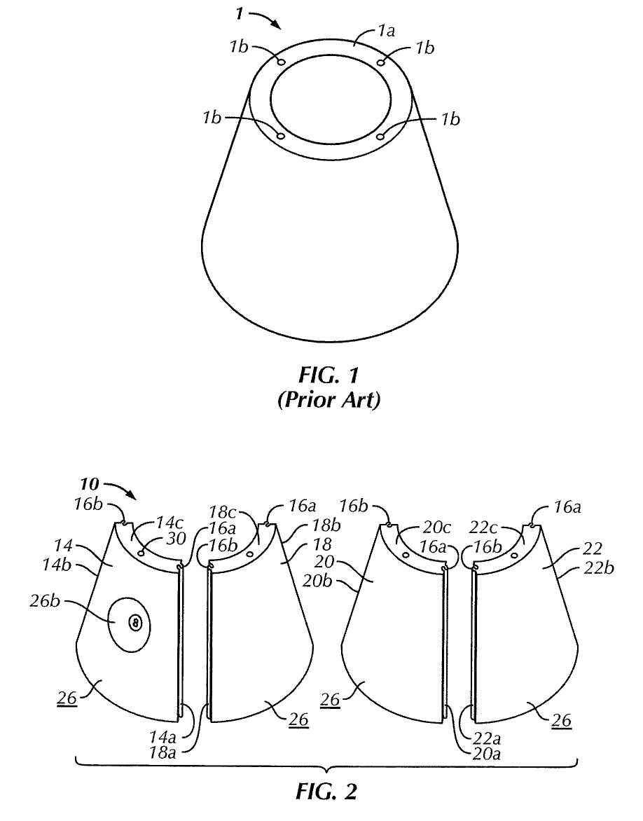

Referring to FIG. 4, in a shipping configuration (not shown), the shade portions 14, 18, 20, 22 are preferably stacked on top of one another such that the inner surface 24 of the first shade portion 14 is positioned proximate the outer surface 26 of the second shade portion 18, the inner surface 24 of the second shade portion 18 is positioned proximate the outer surface 26 of the third shade portion 20 and the inner surface 24 of the third shade portion 20 is positioned proximate the outer surface 26 of the fourth shade portion 22 as shown by the arrows in FIG. 4. However, the shade portions 14, 18, 20, 22 may be stacked in any similar configuration such that their respective inner surfaces 24 are positioned proximate or in facing engagement with the respective outer surfaces 26 of an adjacent shade portions 14, 18, 20, 22. Positioning the shade portions 14, 18, 20, 22 in the shipping configuration provides a relatively compact configuration for shipping and storage that encompasses a significantly smaller volume, approximately one-fourth the size in the first preferred embodiment of the shade 10, for shipping the shade 10 when compared to the conventional one-piece prior billiard shade 1 shown in FIG. 1. In addition, the consolidation of the shade portions 14, 18, 20, 22 in the shipping configuration generally makes the shade portions 14, 18, 20, 22 more stable during shipping and reduces the amount of packing required within the shipping container. The volume of the shade 10 in the shipping configuration also provides for significant shipping cost savings and convenience for the manufacturer, distributor, retailer and consumer.

Each first side edge 14a, 18a, 20a, 22a preferably includes a first interlocking structure 16a. Each second side edge 14a, 18a, 20a, 22a preferably includes a second interlocking structure 16b that engages with the first interlocking structure 16a of an adjacent shade portion 14, 18, 20, 22. The first and second interlocking structures 16a, 16b are preferably constructed of a snap-lock structure that is integral with the first and second side edges 14a, 18a, 20a, 22a and 14b, 18b, 20a, 22b, respectively to attach adjacent shade portions 14, 18, 20, 22. For example, the first interlocking structure 16a of the first shade portion 14a connects to the second interlocking structure 16b of the second shade portion 18. The first and second interlocking structures 16a, 16b are not limited to integral snap-lock-type interlocks and may be constructed of nearly any interlocking structure that is able to mount or secure the first shade portion 14 relative to the second shade portion 18. For example, the first and second interlocking structures 16a, 16b may include screws, bolts, other fasteners, hook and loop material, tongue and groove-type structures or nearly any interlocking hardware or construction that is able to mount one of the shade portions 14, 18, 20, 22 to the adjacent shade portions 14, 18, 20, 22.

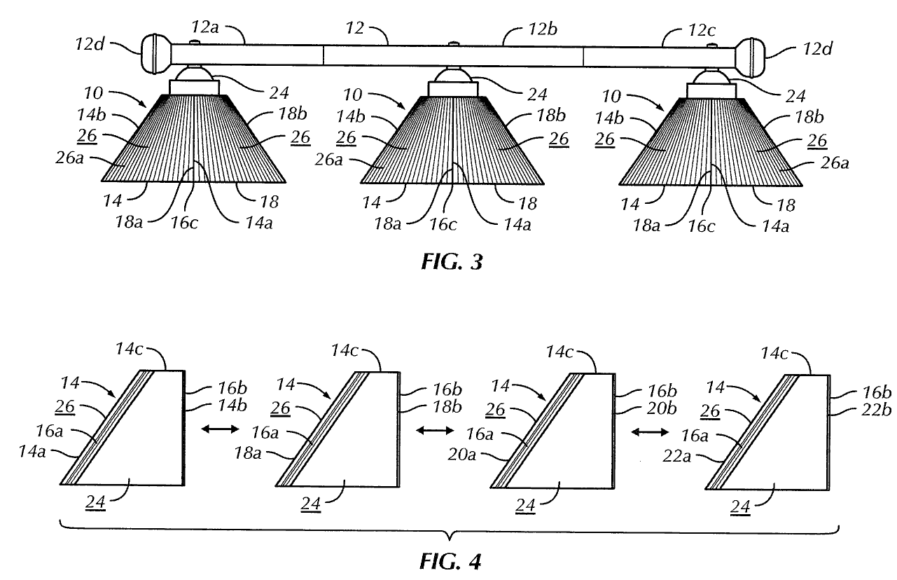

Referring to FIGS. 2 and 3, the seam 16c between the shade portions 14, 18, 20, 22 in an assembled configuration (FIG. 3), for example the seam 16c where the first side edge 14a of the first shade portion 14 and the first side edge 18a of the second shade portion 18 adjoin, is preferably hidden or at least partially concealed to give the impression of a one-piece shade 10 in the assembled configuration. The outer surfaces 26 of the shade portions 14, 18, 20, 22 may be contoured by lines or ridges 26a (FIG. 3) or may be otherwise configured to hide or minimize the external ornamental appearance of the seam 16c between the shade portions 14, 18, 20, 22. The seam 16c is shown more prominently than the ridges 26a in FIG. 3 for illustrative purposes. However, the shade 10 is not limited to inclusion of contours 26a or other structures that hide the seam 16c between the shade portions 14, 18, 20, 22 and may include a relatively prominent seam 16c. However, the seam 16c is preferably hidden to give the appearance of a one-piece billiard shade in the assembled configuration and to provide a pleasing ornamental appearance for a user or observer. In addition, in the assembled configuration, the shade 10 preferably has a similar or nearly identical performance when compared to known billiard shades 1 for appearance purposes and for directing light onto a billiard table or other desired area.

The shade portions 14, 18, 20, 22 may also or alternatively include a symbol 26b or logo (FIG. 2), such as a graphic or advertisement, printed on their outer surfaces 26. The individual shade portions 14, 18, 20, 22 are typically more convenient for a manufacturer to work with or print on when compared to the conventional one-piece shade 1, which requires printing around an entire three hundred sixty degree (360°) surface area of the prior art shade. In contrast, the individual shade portions 14, 18, 20, 22 provide a more compact, generally smaller and convenient surface to print on for the manufacturer or printer. The ability to print a symbol or logo on the shade portions, 14, 18, 20, 22 is particularly suited for billiard applications as billiard shades often include printing of symbols, logos or advertisements thereon. The printing on the shade portions 14, 18, 20, 22 may also be adapted for the individual shade portions 14, 18, 20, 22 to create an overall ornamental appearance for the shade 10 or may be adapted such that the shade portions 14, 18, 20, 22 may be removed and replaced to update advertising in the billiard room or at any location where the shade 10 may be utilized. The shade portions 14, 18, 20, 22 are not limited to including printing thereon and may have contoured or textured surfaces to create a desired ornamental appearance or may have a painted or unfinished outer surface 26 to create a desired ornamental appearance. In addition, the inner surfaces 24 may include reflective properties to reflect the light from the light bulbs in a specific direction or onto a specific surface in the location where the light fixture 24 is mounted.

Referring to FIGS. 2-4, in operation, a manufacturer constructs the shade portions 14, 18, 20, 22 through injection molding, stamping, bending or nearly any manufacturing technique that results in construction of the general form and shape of the first, second, third and fourth shade portions 14, 18, 20, 22. The manufacturer then aligns the shade portions 14, 18, 20, 22 as is shown in FIG. 4 and stacks the shade portions 14, 18, 20, 22 such that the respective outer surfaces 26 are in facing engagement or positioned proximate to the respective inner surfaces 24. A single set of shade portions 14, 18, 20, 22 may be stacked and assembled into a container for shipping, or multiple sets of shade portions 14, 18, 20, 22 may be stacked into a single shipping container (not shown). For example, if a billiard lamp assembly includes three assembled shades 10 and three light fixtures 24, as is shown in FIG. 3, the appropriate number of shade portions 14, 18, 20, 22, such as twelve in the illustrated example, may be stacked and shipped in a single container along with the light bar and associated light fixtures 24 for assembling the completed billiard lamp shade assembly shown in FIG. 3. The ability to stack the shade portions 14, 18, 20, 22 in the relatively compact shipping configuration provides for cost reductions in shipping for the manufacturer, distributor, retailer and consumer, as well as providing for convenience in transport and display on a retail shelf (not shown). In addition, the preferred shade portions 14, 18, 20, 22 may be identical in shape and configuration, resulting in any assembled combination of the shade portions 14, 18, 20, 22 defining the billiard shade 10. Accordingly, if a shade portion 14, 18, 20, 22 is lost or broken, the individual shade portion 14, 18, 20, 22 may be replaced and assembled with the remaining shade portions 14, 18, 20, 22 to construct the shade 10.

When the package reaches the consumer or other user, the package may be opened and the individual shade portions 14, 18, 20, 22, light fixtures 24 and light bar 12 may be removed for assembly. Specifically, the first side edges 14a, 18a, 20a, 22a are aligned with the corresponding second side edge 14b, 18b, 20b, 22b and the first and second interlocking structures 16a, 16b are snapped together to secure the shade portions 14, 18, 20, 22 together. The order in which the shade portions 14, 18, 20, 22 are attached to each other may vary based on the preference of one of ordinary skill in the art. The assembled shade 10 preferably includes mounting holes 30 proximate the top or apex edges 14c, 18c, 20c, 22c to mount to the light fixtures 24. The light fixtures 24 are then mounted to the light bar 12 to complete the construction of the billiard light assembly. The light bar 12 may have a one-piece construction or may be sectioned to accommodate a relatively compact shipping package for the entire billiard light assembly.

Referring to FIG. 3, the preferred light bar 12 may include a first bar section 12a, a second bar section 12b and a third bar section 12c having bar interlocking structures on appropriate ends. The second bar 12b preferably includes bar interlocking structures (not shown) on each end that are removably mountable to complementary bar interlocking structures on ends of the first and third bar sections 12a, 12c. An opposite end of the first and third bar sections 12a, 12c include decorative end caps 12d. The bar interlocking structures may be comprised of threads, snap locks, fasteners, hook and loop material, tongue and groove-type structures or nearly any fastening or interlocking mechanism that enables removable mounting of the first, second and third bar sections 12a, 12b, 12c with each other. The first, second and third bar sections 12a, 12b, 12c may also be “pre-wired” or include wiring therein to power the light bulbs associated with the billiard shade assembly. For example, the bar sections 12a, 12b, 12c may include quick wiring disconnects on ends that are adjoined to adjacent bar sections 12a, 12b, 12c to connect the wiring in the assembled configuration, or the wiring may extend through the bar sections 12a, 12b, 12c and bend into a storage position, similar to a tent pole to facilitate compact storage and/or shipping of the preferred light bar 12. The light bar 12 is not limited to being “pre-wired” and may include no wiring therein or may include partial wiring that is supplemented by a user during assembly of the light bar 12. The removable mounting of the bar sections 12a, 12b, 12c to each other facilitates a relatively compact shipping configuration for the light bar 12.

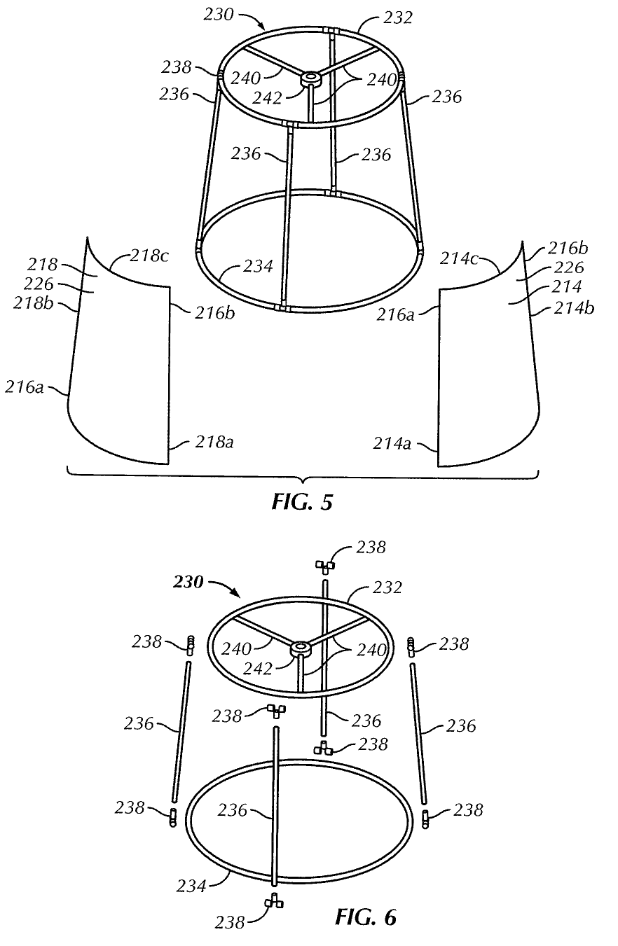

FIGS. 5 and 6 shown a second preferred embodiment of the shade, generally 210. The shade 210 is similar to the first embodiment of the shade 10, except that the shade 210 may include a knockdown frame 230. The shade portions 214, 218 are preferably removably mountable to the knockdown frame 230. In FIG. 5, only the first and second shade portions 214, 218 are shown, however, the preferred shade 210 of the second embodiment includes four shade portions that are removably mountable to the knockdown frame 230. The shade 210 is not limited to the inclusion of four shade portions and may include nearly any number of shade portions 214, 216 that are removably mountable to each other and/or to the knockdown frame 230. The knockdown frame 230 is preferably able to be assembled and disassembled by a user such that the shade 210 may be assembled in a working configuration and disassembled for shipping in a shipping configuration.

The knockdown frame 230 has a generally cylindrical shape that tapers from an upper ring 232 to have a slightly larger diameter at a lower ring 234. The preferred knockdown frame 230 also preferably includes vertical supports 236 that space the upper ring 232 from the lower ring 234 in the assembled configuration and mounting tabs 238 that secure the ends of the vertical supports 236 to the upper and lower rings 232, 234. The mounting tabs 238 preferably have an axially extending slit (not shown) that can be expanded such that the mounting tabs are positioned over the upper and lower rings 232, 234 as shown in FIG. 5. The mounting tabs slidingly receive the vertical supports 236 through an interference or snap fit. The mounting tabs 238 are preferably removably mountable from the ends of the vertical supports 236 and from the upper and lower rings 232, 234 such that the knockdown frame 230 is able to be alternately assembled and disassembled to and between the working configuration and the shipping configuration. However, the mounting tabs 238 are not limited to being removably mountable from both the vertical supports 236 and the upper and lower rings 232, 234 and may be permanently secured to the vertical supports 236 and the upper and/or lower rings 232, 234 or may be comprised of alternative mechanisms that are able to removably mount the vertical supports 236 to the upper and lower rings 232, 234. The vertical supports 236 and upper and lower rings 232, 234 are preferably constructed of a metallic wire-type construction but may be constructed of nearly any material having nearly any shape that is able to form the knockdown frame 230 and be alternatively assembled and disassembled to and from the working and shipping configurations.

The upper ring 232 also preferably includes lateral supports 240 that extend radially outwardly from a central mounting ring 242 to provide support and stability to the upper ring 232. The mounting ring 242 is generally well known in the lampshade art and is typically utilized to mount the knockdown frame 230 to a light fixture (not shown). The knockdown frame 230 is not limited to inclusion of the mounting ring 242 or the lateral supports 240 and may be alternatively mounted to a light fixture, depending upon the type of light fixture that is being shaded. In addition, the knockdown frame 230 is not limited to the above-described configuration including the upper and lower rings 232, 234, the vertical supports 236 and mounting tabs 238 and may be comprised of nearly any shape, size and/or configuration of a knockdown frame for a light fixture, various configurations of which would be apparent to one having knowledge of knockdown shades.

Referring to FIG. 5, the shade portions 214, 218 are removably mountable relative to the knockdown frame 230 when the knockdown frame 230 is in the working configuration in the preferred second embodiment. Specifically, the first shade portion 214 is preferably mountable to one of the vertical supports 236 through the first interlocking structure 216 and the second shade portion 218 is mountable to one of the vertical supports 236 through the second interlocking structure 216b. The additional edges 214b, 214c, 218b, 218c may also be removably mounted or interlocked to the vertical supports 236 or the upper or lower rings 232, 234. Alternatively, the shade portions 214, 218 may be partially interlocked with each other and partially interlocked to the knockdown frame 230 to construct or assemble the billiard shade 210 in the working position of the second embodiment.

The billiard shade 210 and the knockdown frame 230 are not limited to having the generally cylindrical configuration and may have nearly any shape and/or size that is desired by a user for a shade for a light fixture. For example, the knockdown frame 230 may have a generally rectangular or octagonal-shape and the shade portions 214, 218 would be adapted to removably mount to such a knockdown frame.

In operation, the mounting tabs 238 are secured to each of the ends of the vertical supports 236 and are mounted to the upper and lower rings 232, 234 such that the vertical supports 236 are positioned generally in a perpendicular orientation to the upper and lower rings 232, 234 to position the knockdown frame 230 in the working configuration. The shade portions 214, 218 are then mounted to the knockdown frame 230 to preferably create a continuous shade around the knockdown frame 230. The assembled billiard frame 210 is then mounted to a lighting fixture to shade the lighting fixture. To disassemble the shade 210, the mounting tabs 238 are released from the upper and lower rings 232, 234 and are removed from the ends of the vertical supports 236. The upper and lower rings 232, 234, vertical supports 236 and mounting tabs 238 may then be positioned in a shipping configuration and placed in a shipping container. In a shipping container, the knockdown frame 230 takes up significantly less space than the knockdown frame 230 in the working configuration. Accordingly, the packaging and costs for shipping for the knockdown frame 230 in the shipping configuration is significantly reduced when compared to costs and/or convenience for shipping the assembled knockdown frame 230. The knockdown frame 230 and the shade portions 214, 218 may be stored for shipping in the same container in the shipping configuration, thereby reducing the required size of the shipping container. Similar to the shade 10 of the first embodiment, the removable shade portions 214, 218 are more easily printed on or otherwise decorated prior to assembly of the shade 210.

It will be appreciated by those skilled in the art that changes could be made to the embodiments described above without departing from the broad inventive concept thereof. For example, the shade 10, 210 may be constructed of one or more shade portions or a single shade portion having a flexible configuration, assembled together to define the assembled shade 10, 210. It is understood, therefore, that this invention is not limited to the particular embodiments disclosed, but it is intended to cover modifications within the spirit and scope of the present invention as defined by the appended claims.

I claim:

1. A shade for mounting to a light fixture to direct light from a bulb onto a desired area, the shade comprising:
a plurality of shade portions, each shade portion including a first side edge and a second side edge, the first side edge including a first interlocking structure and the second side edge including a second interlocking structure, the second interlocking structure of one of the shade portion engaging the first interlocking structure of another shade portion to mount the shade portions to each other in an assembled configuration.

2. The shade of claim 1, wherein the shade portions have a generally arcuate-shape such that the shade is frusto-conical in shape when assembled.

3. The shade of claim 1, wherein there are four shade portions.

4. The shade of claim 1, wherein the first and second interlocking structures form a releaseably engaging snap-fit.

5. The shade of claim 1, wherein the shade is part of a billiard light fixture.

6. The shade of claim 1, wherein the shade portions include an inner surface and an outer surface, the inner surface of the first shade portion being positioned proximate the outer surface of the second shade portion in a shipping configuration.

7. The shade of claim 1, wherein the shade portions are semi-transparent.

8. The shade of claim 1, wherein the shade portions have a textured outer surface.

9. The shade of claim 1, wherein at least one of the shade portions includes a symbol printed thereon.

10. A billiard light fixture for mounting over a billiard table and projecting light onto a billiard table and into a room wherein the billiard table is located, the billiard light fixture comprising:
a light bar mounted over the billiard table;
a first light bulb mounted to the light bar; and
a plurality of shade portions, each shade portion including a first side edge and a second side edge, the first side edge including a first interlocking structure and the second side edge including a second interlocking structure, the second interlocking structure of one of the shade portion engaging the first interlocking structure of another shade portion to mount the shade portions to each other in an assembled configuration.

11. The billiard light fixture of claim 10, wherein the light bar includes a first bar section and a second bar section that are removably mountable to each other.

12. The billiard light fixture of claim 10 further comprising:
wiring mounted within the first and second bar sections to provide electric power to a light bulb associated with the billiard light fixture.

13. The billiard light fixture of claim 10 further comprising:
a second light bulb mounted to the light bar; and
a second shade mounted proximate the second light bulb to deflect light from the second light bulb onto the billiard table, the light bar including first and second bar sections, the first light bulb mounted to the first bar section and the second light bulb mounted to the second bar section.

14. A shade for use with a light fixture within a room used to project light into the room, the shade comprising:
a knockdown frame being movable between a working configuration and a shipping configuration, the knockdown frame encompassing a larger volume in the working configuration in comparison to an encompassed volume in the shipping configuration; and
a shade portion removably mounted to the knockdown frame.

15. The shade of claim 14, wherein the knockdown frame includes an upper ring and a lower ring, the lower ring axially spaced from the upper ring and having a larger diameter than the upper ring.

16. The shade of claim 15, wherein the upper ring is removably joined to the lower ring by a plurality of axially extending vertical supports in an assembled position.

17. The shade of claim 14, wherein the shade portion includes a plurality of shade portions, each shade portion being removably mountable to a portion of the knockdown frame in the assembled configuration.

18. The shade of claim 14, wherein the upper ring includes a plurality of lateral supports that extend radially outwardly from a central mounting ring.
